(19) United States
(12) Patent Application Publication
(10) Pub. No.: US 2025/0135841 A1
(43) Pub. Date: May 1, 2025

(54) Heat Pump Module for a Vehicle, Axle Assembly and Vehicle

(71) Applicant: ZF Friedrichshafen AG, Friedrichshafen (DE)

(72) Inventors: Axel Rohm, Schonungen (DE); Joel Kring, Hayingen-Anhausen (DE)

(21) Appl. No.: 18/932,721

(22) Filed: Oct. 31, 2024

(30) Foreign Application Priority Data
Oct. 31, 2023 (DE) 102023210775.9

(51) Int. Cl. B60H 1/32; B60H 1/00

(52) U.S. Cl. CPC B60H 1/3223; B60H 1/3229; B60H 2001/006; B60H 2001/3292

(57) ABSTRACT

A heat pump module (10) for a vehicle includes at least one drivable component (11) configured to generate vibrations during operation and at least one decoupling element (12) configured to decouple the at least one component (11) such that generated vibrations are not transmitted or are at least damped, in particular when the heat pump module (10) is installed, to decouple the at least one component from a vehicle structure of the vehicle.

### CROSS-REFERENCE TO RELATED APPLICATION

The present application is related and has right of priority to German Patent Application No. DE102023210775.9 filed on Oct. 31, 2023, which is incorporated by reference in its entireties for all purposes.

### TECHNICAL FIELD

The present invention relates generally to a heat pump module for a vehicle, in particular an electric or hybrid vehicle, to an axle assembly having such a heat pump module, and to a vehicle.

### BACKGROUND

Vehicles, in particular electric vehicles and hybrid vehicles, require a cooling system in order to be able to dissipate the power losses that arise in various assemblies during operation and during charging, for example an energy store, an electric machine, and further electronic components, for example an inverter, a DC/DC converter, a DC/AC converter, and the like. The vehicle systems here usually have multiple cooling circuits in order to form a controlled thermal management system. In general, a coolant circuit having a water-glycol coolant is present, via which heat from the individual components can be dissipated to the surroundings. A further cooling circuit includes a heat pump, or an AC compressor, for air conditioning a passenger compartment or for assisting in the dissipation of heat from the components. A third cooling circuit is provided in many systems for dissipating heat from the lube oil and cooling oil-system of the transmission.

Thermal management systems generate noise emissions due to the operation of components thereof, for example pumps, compressors, and the like. The noise emissions or excitations can be compensated for only to a limited extent, as a result of which airborne and structure-borne sound radiation remains, which passengers may be able to hear or even feel. The known systems are formed from a combination of individual components that are distributed more or less widely over the installation space in the vehicle. The components, for example the compressor, are attached to vehicle structures via consoles. Examples from current vehicles show that the positioning of the components is hardly optimized. The issue of noise, vibration, and harshness (NVH) is hardly or not at all taken into account in the positioning of the components, as a result of which additional measures, for example in the form of insulation, or insulating shells, are necessary. Mainly, the focus is on airborne sound emissions, but structure-borne sound is nevertheless transmitted into the interior, resulting as vibrations that can be felt at the steering wheel, in the pedals, and even through the seats.

### BRIEF SUMMARY

Example aspects of the present invention provide a heat pump module that has better properties with respect to noise, vibration, and harshness. Example aspects of the present invention also provide an axle assembly and a vehicle.

According to one example aspect of the present invention, a heat pump module for a vehicle is provided, in particular for an electric vehicle, a hybrid vehicle, or a vehicle powered by hydrogen, which heat pump module includes: at least one drivable component, wherein the at least one component generates vibrations during operation; and at least one decoupling element, which is designed to decouple the at least one component so that generated vibrations are not transmitted or are at least damped, in particular when the heat pump module is installed, to decouple generated vibrations from a vehicle structure of the vehicle.

As compared to the known prior art, the heat pump module provides the advantage of allowing the vibration-generating, drivable component to be decoupled from a vehicle structure, for example from a passenger compartment of the vehicle, by the decoupling element. As a result, the noise, vibration, and harshness properties of the heat pump module are improved. Furthermore, insulation on a vehicle can be reduced.

According to one example aspect of the present invention, the heat pump module is intended for use in a vehicle. More precisely, the heat pump module is intended for use in an electric vehicle, in a hybrid vehicle, or in a vehicle powered by hydrogen. It is possible to arrange the heat pump module in the region of the rear or in the region of the front of the vehicle (relative to a main direction of travel).

The term “heat pump module” is considered to mean a component of a vehicle that generates vibrations and/or noise during operation. This is, for example, an assembly or arrangement having a heat pump, which can be handled as a unit. It is conceivable that the heat pump module includes individually drivable components. The heat pump module preferably includes at least one heat pump. The heat pump module can preferably have further components, for example compressors, pumps, drives, connections, and/or valves. The heat pump module can be installed, for example, in a cooling circuit of a vehicle. In particular, the heat pump module can be provided as part of a thermal management system. In other words, the heat pump module according to example aspects of the present invention can be used in a cooling circuit or a thermal management system of a vehicle.

According to one example aspect of the present invention, the drivable component can include a work machine and/or a prime mover and/or a combination of the two aforementioned machines. The drivable component can also be any other component, however, that generates vibrations and/or noise. A prime mover is distinguished by the fact that energy, for example chemical, thermal or electrical energy, is converted into mechanical energy. A work machine is distinguished by the fact that the work machine gains energy in the form of mechanical work. For example, the heat pump module includes a compressor and/or a pump (work machines) and/or an electric motor (prime mover) for driving the compressor, or the pump.

The drivable component may generate vibrations during operation. The drivable component can therefore generate vibrations when a main function is carried out. The main function of the drivable component is to be understood as a function that is necessary for the function of the heat pump module. In other words, the generation of vibrations is a side effect of the drivable component. Thus, vibrations arise, for example, due to pressure thrusts that happen during the compression of a refrigerant in the compressor. More precisely, a side effect of the main function of the compressor, specifically the compression of a refrigerant, is that vibrations are generated.

Vibrations are to be understood in the present case as mainly mechanical oscillations. In particular, vibrations are to be understood as mechanical oscillations that can be heard and/or felt. The vibrations can also be referred to as structure-borne sound. The vibrations can be perceived, for example, as shaking, which is perceived by a driver of a vehicle as distracting during operation. The vibrations are accompanied at least in part by an audible acoustic sound is to be avoided.

The decoupling element is designed to decouple the at least one drivable component so that generated vibrations are not transmitted or are at least damped. For example, when the heat pump module is installed in a vehicle, the drivable component of the heat pump module can thus be decoupled from a vehicle structure so that vibrations and sound emissions are not readily transmitted, in particular into the passenger compartment. In other words, the decoupling element is used to at least dampen vibrations that are generated by the drivable component, or preferably to substantially completely prevent transmission of the generated vibration. A decoupling is to be understood as a mechanical decoupling. In addition to the mechanical decoupling, the position and orientation of the heat pump module, or of the vibration-generating, drivable component, on the vehicle is to be understood as a decoupling element. The position and orientation of the vibration-generating, drivable component defines the emission direction, or the excitation direction, of the vibration. It is advantageous that the emission direction, or the excitation direction, of the vibration-generating, drivable component is directed away from a vehicle structure.

The emission direction, or the excitation direction, of the vibrations is to be understood as a direction of the vibrations in which the vibrations can excite further vibrations, or oscillations. Furthermore, the emission direction can describe a direction in which the vibrations are emitted from the component. For example, the drivable component vibrates, or oscillates, along a longitudinal axis, in particular back and forth. Therefore, the emission direction, or excitation direction, can be understood as a direction along the longitudinal axis, since the vibrations—when a body is coupled to the drivable component—would also be excited to vibrate, or oscillate, in this direction.

In one example embodiment, the component includes a compressor unit, which is configured to compress a refrigerant by a compression process, wherein the vibrations result from the compression process. The compressor unit can include a scroll compressor, a radial compressor, a screw compressor, or another type of compressor.

In one example embodiment, the component includes a pump unit, which is configured to excite a circulation of a refrigerant, or of a coolant, by a pumping process, wherein the vibrations result from the pumping process. The pump unit can include a piston pump, a centrifugal pump, a peristaltic pump, a gear pump, or another type of pump.

In one example embodiment, the heat pump module includes a drivable component that is in the form of a pump unit, and a drivable component that is in the form of a compressor unit, wherein the pump unit and the compressor unit are oriented relative to each other such that the excitation direction of the generated vibrations from the pump unit and the compressor unit are directed substantially in the same direction.

In one possible example embodiment, the vibrations generated by the drivable component, for example the compression unit, during a compression process point in substantially one first excitation direction, wherein the compression unit is arranged on the heat pump module such that, when the heat pump module is installed on a vehicle, the first excitation direction is directed away from a passenger compartment and/or the first vibrations are mechanically decoupled from a passenger compartment.

In one possible example embodiment, the drivable component, for example the compression unit, generates second vibrations during operation that substantially have a second excitation direction, wherein the drivable component is arranged on the heat pump module such that, when the heat pump module is installed, the drivable component is arranged on a vehicle such that the second excitation direction is directed way from a passenger compartment and/or the second vibrations are mechanically decoupled from a passenger compartment.

In one example embodiment, the heat pump module includes a support element, which is configured to support the at least one drivable component and to mount the heat pump module on a vehicle. The support element can include, for example, a cross-brace, a profile, and/or an axle. The support element has the advantage that multiple components of the heat pump module can be arranged preferably directly next to one another. As a result, vibrations can be at least partially avoided or insulated. Furthermore, as a result, the heat pump module is easier to handle and mount.

In one possible example embodiment, the heat pump module includes a first heat exchanger, which is arranged on the support element and is configured to transmit thermal energy to the refrigerant and to evaporate the refrigerant, and a second heat exchanger, which is arranged on the support element and is configured to draw energy from the refrigerant and to liquefy the refrigerant. In one example embodiment, the heat pump module also includes an expansion unit, in particular an expansion valve, which is designed to cool down the refrigerant by reducing the pressure.

In one example embodiment, the at least one decoupling element is arranged on the support element and is configured to connect the heat pump module to a structural element of a vehicle. Due to the arrangement of the decoupling element on the support element, it is possible that vibrations are indirectly transmitted onto the decoupling element. As a result, the risk of self-oscillations is reduced. Furthermore, in this way, the orientation of the drivable component relative to the vehicle and the excitation direction of the vibrations can be established. Due to the orientation of the heat pump module and, therefore, of the drivable component, the vibrations can be decoupled, in particular from a passenger compartment.

In one example embodiment, the decoupling element includes at least two, preferably three, elastic connectors. The elastic connectors bring about a damping and, therefore, a decoupling of the vibrations that are generated by the drivable component. For the elastic connectors, for example, mechanical springs and/or elastic materials can be used. Due to the number of connectors, an at least partially, preferably a completely statically determinate system can be implemented for attaching the heat pump module to a vehicle.

In one example embodiment, the elastic connectors of the decoupling element have different spring stiffnesses. It is advantageous to provide a non-linear, preferably a progressive spring stiffness of the elastic connectors. When a mechanical oscillation is excited, a shift of the amplitude can therefore be brought about and vibrations can be damped.

In one example embodiment, the elastic connectors are preferably asymmetrically arranged in space. The asymmetrical arrangement in space is to be understood, in particular, as different distances of the elastic connectors from one another. In this way, the damping properties can be improved.

In one example embodiment, at least some parts of the support element and/or of the decoupling element have an irregular geometry. The irregular geometry can also be referred to as asymmetrical or stochastic geometry. Due to the irregular geometry of the support element and/or of the decoupling element, a resonance formation of the vibrations, or of the mechanical oscillations, is prevented.

In one example embodiment, at least some parts of the support element include cutouts/through-holes, wherein the cutouts/through-holes have differing, in particular irregular, geometries. The irregular geometry can also be referred to as asymmetrical or stochastic geometry. The cutouts/through-holes reduce the formation of acoustic sound from the vibration. Furthermore, due to the irregular geometries of the cutouts/through-holes, a resonance formation of the vibrations, or of the mechanical oscillations, is prevented. The cutouts also minimize transmission of the structure-borne sound. Structure-borne sound is to be understood as the sound that propagates in a solid body. Vibrating bodies can cause the surrounding air to vibrate, enabling this to be audible as airborne sound.

According to a further example aspect of the present invention, an axle assembly having a heat pump module, in particular according to one of the preceding example embodiments, is provided, wherein the axle assembly has two wheel heads spaced apart in an axial direction of the axle assembly, wherein the heat pump module is arranged on the axle assembly by the decoupling element such that the vibrations that can be generated by the drivable component are emitted in an emission direction, wherein the emission direction runs at least partially along the axial direction and/or orthogonally thereto. The emission direction can also be referred to as the excitation direction.

The axle assembly can also include a power electronics system, in particular an inverter, an electric machine, a parking lock, and/or a transmission. In addition, it is conceivable that the axle assembly has a cooling system.

The heat pump module is arranged on the axle assembly preferably by the decoupling element such that the vibrations generated by the component are mechanically decoupled from a passenger compartment of the vehicle, in particular wherein an emission direction, or excitation direction, of the vibrations extends in a direction that is at least partially orthogonal to an intended direction of travel of the axle assembly.

The intended direction of travel of the axle assembly is to be understood as the direction in which the vehicle moves when all wheel heads of the axle assembly, or all tires of the vehicle, are parallel to one another. In other words, the intended direction of travel is to be understood as a linear direction of travel.

According to a further example aspect of the present invention, a vehicle, in particular an electric vehicle, a hybrid vehicle, or a vehicle powered by hydrogen, is provided with a heat pump module, in particular according to one of the preceding example embodiments, wherein the heat pump module is arranged by the decoupling element such that vibrations generated by the component are mechanically decoupled from a passenger compartment of the vehicle.

In consideration of the possible emission directions, or excitation directions, which are dependent on the drivable component, it is advantageous to select the installation orientation and/or installation position of the drivable component, for example a scroll compressor, such that the emission direction, or the excitation direction, of the vibrations does not extend in the longitudinal direction of a body structure of the vehicle, which is a direct path into the passenger compartment. It is advantageous, therefore, to select the position and orientation of the drivable component such that introduced excitations due to vibrations act on the body structures along a transverse direction and thus a direct transmission into a passenger compartment of the vehicle is at least reduced.

In this way, it is possible to bring about a decoupling of the generated vibrations by arranging the drivable component directly on a body structure that extends in a transverse direction of the vehicle, such that generated vibrations are not transmitted or are at least damped in order to decouple the vibrations, in particular from a vehicle structure of the vehicle.

The drivable component of the heat pump module arranged on the vehicle includes, preferably, a compressor unit, in particular a scroll compressor, wherein the compressor unit is arranged on the vehicle such that vibrations generated by the drivable component are mechanically decoupled from a passenger compartment of the vehicle, in particular wherein the emission direction, or excitation direction, of the vibrations extends in a direction that is at least partially orthogonal to a direction of travel.

A direction of travel is understood here to be a linear direction of travel of the vehicle.

It is particularly advantageous when the heat pump module is arranged on a body element or a structural element of the vehicle that extends orthogonally to a direction of travel, in particular an axle beam and/or a crossmember and/or a suspension cross-brace.

It is advantageous to select the installation orientation and/or installation position of the drivable component such that the excitation direction of the vibrations does not extend in the longitudinal direction of a body structure, which is a direct path into the passenger compartment.

According to one possible example embodiment, the drivable component includes a scroll compressor. The scroll compressor has two essential sources from which vibrations originate. These are, on the one hand, the eccentric components of the scroll compressor and the imbalances which result therefrom and excite vibrations in a radial direction, and, on the other hand, pressure oscillations that arise due to compression fluctuations between two ejection processes. In consideration of these causes and their excitation direction, it is advantageous to select the installation direction and/or installation position of the drivable component, specifically the scroll compressor in this case, preferably such that the emission direction, or excitation direction, of the vibrations does not extend in a longitudinal direction of a body structure, which is a direct path into the passenger compartment. It is therefore advantageous to select the position of the drivable component such that radially excited vibrations that may have been introduced act perpendicularly on the body structures and thus a direct transmission into a passenger compartment of the vehicle is avoided.

It is alternatively or additionally possible, furthermore, to arrange the heat pump module on the vehicle together with a drive unit, in particular an electrical drive unit. In this example embodiment, the heat pump module is mounted, for example, on the axle beam on which the electrical drive unit is also seated. In particular, this example embodiment is advantageous when the axle beam is connected to the body by elastic connectors. Alternatively, it is possible to connect the heat pump module directly and fixedly to the drive unit, or to the housing thereof, as a result of which the mass to be excited increases, for example by a factor between five (5) and fifteen (15). In particular, the drive unit is generally connected to the body via elastic connectors for decoupling the vibrations, or oscillation excitations, originating from the electric machine (drive unit), such that an additional elastic connection to the body can be dispensed with or the support element can be omitted by fixedly connecting the elastic connectors directly to the housing of the drive unit.

In addition to the type of the mechanical connection in the vehicle, the position, or the orientation, of the vibration-generating, drivable component of the heat pump is also to be understood as a decoupling element because, via such position/orientation, vibrations and sound emissions, in particular into the passenger compartment, can be reduced.

It can also be advantageous to fixedly arrange the compressor on the support element, wherein the support element has, in particular, a shape that has an irregular geometric structure with openings and through-holes in order to prevent, by different stiffnesses, a formation of resonance and a transmission of structure-borne sound. Preferably, the further components of the heat pump (heat exchanger, etc.) are also rigid and connected as closely as possible to the compressor and the component support, whereby the greatest possible mass to be excited is achieved.

The heat pump module can be connected to the vehicle preferably via elastic connectors or interfaces, wherein in this case as well a structure is to be preferred that, similarly to the aforementioned support element, has no geometrically regular, or symmetrical, contiguous areas. The connectors have, for example, asymmetrical through-holes or interruptions in order to avoid a direct transmission of oscillations. The connectors are also designed preferably as cross-braces.

In addition, the heat pump module is connected to the vehicle via at least two, preferably precisely three elastic connectors having a defined spring rate and damping, in a punctiform manner, wherein the geometric arrangement of the elastic connectors is configured such that symmetry is avoided in all spatial directions. Depending on the constraints, the stiffnesses of the elastic connectors are selected to be identical or different in order to influence the vibration characteristics, wherein it is useful to design the spring rate to be non-linear, preferably progressive, in order to achieve an amplitude shift when oscillation is introduced.

Excitations that are introduced into the vehicle body via the decoupling element transmit vibrations into the passenger compartment that can excite flat components and are expressed as airborne sound. Transmission paths and/or nodes play a definitive role here. Therefore, the module is to be arranged in the vehicle as far away as possible from the passenger compartment, in particular from the driver's seat. The preferred installation position is in the front end, on the right, as low as possible (in the direction of the roadway), for example, on the support frame/axle beam, or in the vehicle rear, wherein a direct connection to the body is to be avoided by using, for example, support frames, etc.

A further example aspect of the present invention is a use of a compressor, in particular a scroll compressor, or a pump in a heat pump module according to one of the preceding example embodiments, or in an axle assembly according to the aforementioned example embodiment.

Individual features or embodiments of the present invention can be combined with other features or other embodiments and, in this way, form new embodiments. Advantages and developments that are mentioned for the features or embodiments apply similarly also to the new embodiments. Developments and advantages that are mentioned in connection with the device apply similarly also to the method, and vice versa.

### BRIEF DESCRIPTION OF THE DRAWINGS

Example aspects of the present invention are described in detail in the following with reference to the accompanying figures, in which:

FIG. 1 is a schematic view of a heat pump module according to one example embodiment of the present invention.

FIG. 2 is a schematic view of a vehicle having a heat pump module according to one example embodiment of the present invention.

FIG. 3 is a schematic view of a vehicle having a heat pump module according to one example embodiment of the present invention.

FIG. 4 is a schematic view of a vehicle having a heat pump module according to one example embodiment of the present invention.

FIG. 5 is a schematic view of a vehicle having a heat pump module according to one example embodiment of the present invention.

FIG. 6 is a schematic view of a vehicle having a heat pump module according to one example embodiment of the present invention.

FIG. 7 is a schematic view of a vehicle having a heat pump module according to one example embodiment of the present invention.

FIG. 8 is a schematic view of a vehicle having a heat pump module according to one example embodiment of the present invention.

FIG. 9 is a schematic view of a vehicle having a heat pump module according to one example embodiment of the present invention.

FIG. 10 is a schematic view of a vehicle having a heat pump module according to one example embodiment of the present invention.

FIG. 11 is a schematic view of a vehicle having a heat pump module according to one example embodiment of the present invention.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

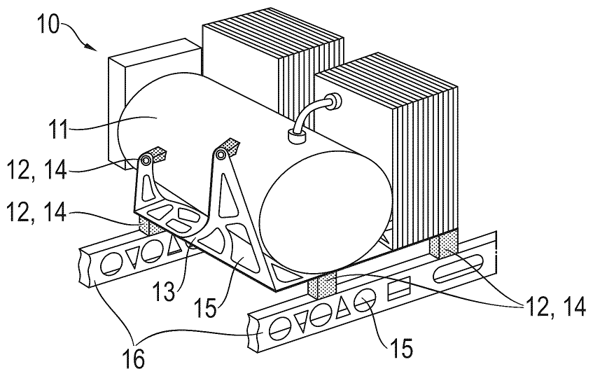

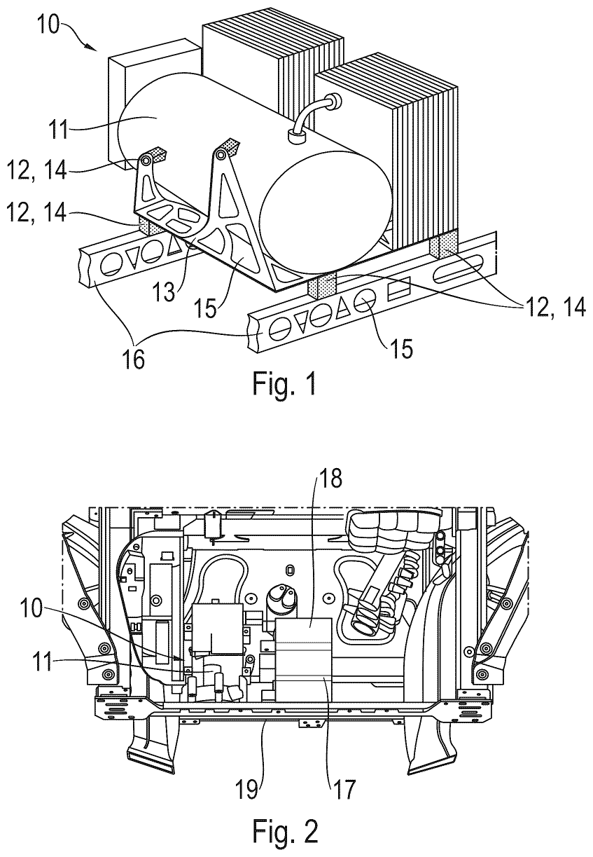

FIG. 1 shows one possible example embodiment of a heat pump module 10. The heat pump module 10 has a drivable component 11. The drivable component 11 is, in the present example embodiment, a compressor unit, in particular a scroll compressor.

The compressor unit 11 is arranged on a support element 13. The compressor unit is connected to the support element 13 by decoupling elements 12.

At least some parts of the support element 13 have an irregular geometry. The support element 13 has multiple cutouts 15. The cutouts 15 have irregular geometries. More precisely, the geometry in the support element 13 is preferably asymmetrical and/or stochastic. This means that at least the geometries of directly adjacent cutouts 15 differ from one another.

The compressor unit 11 is connected by two decoupling elements 12. The decoupling elements 12 are asymmetrically arranged on the compressor unit 11. More precisely, the elastic connectors 14 of the decoupling elements 12 are arranged spatially offset from one another on the compressor unit 11.

The support element 13 is connected to a structural element 16 via further decoupling elements 12 which are in the form of elastic connectors 14. The structural element 16 can form a further part of the support element 13. In another conceivable example embodiment, the structural element 16 can be part of a vehicle structure, for example a body of a vehicle. Alternatively, the structural element 16 can be part of an axle assembly. The structural elements 16 in the present case are in the form of profiled elements. The structural elements 16 have multiple cutouts 15. The cutouts 15 extend at least through one surface of the profiled elements. The cutouts 15 have irregular geometries. More precisely, the geometry in the structural elements 16 is preferably asymmetrical and/or stochastic. This means that at least the individual geometries of the directly adjacent cutouts 15 differ from one another.

The cutouts 15 in the support element 13 reduce the surface area of the heat pump module 10 that can be excited by vibrations originating from, or generated by, the drivable component 11. The cutouts 15 that are arranged in the structural element 16 perform the same function.

The decoupling elements 12 include elastic connectors 14. The elastic connectors 14 preferably have a mechanical spring and/or an elastic material. It is advantageous when the elastic connectors have defined, preferably different, spring stiffnesses. As a result, it is possible to avoid exciting the heat pump module 10 with a characteristic frequency.

The heat pump module 10 shown in FIG. 1 also has an evaporator unit 17 and a condenser unit 18. The evaporator unit 17 and the condenser unit 18 are fluidically connected to the compressor unit 11. The evaporator unit 17 and the condenser unit 18 are arranged directly next to the compressor unit 11 on the support element 13. More precisely, it is advantageous when the distance between the evaporator unit 17 and the condenser unit 18 is as small as possible. As a result, the heat pump module 10 has the greatest possible mass, as a result of which vibrations are reduced.

FIG. 2 shows one possible installation position of the heat pump module 10 in a vehicle. The heat pump module 10 is arranged, in the example embodiment shown, on a transverse axis 19 of the vehicle. The transverse axis extends orthogonally to a longitudinal direction of the vehicle. The compressor unit 11 in FIG. 2 is a scroll compressor. The scroll compressor includes a spiral head that is eccentrically connected to a shaft. The spiral head moves in an orbiting manner during a compression process. This results in vibrations that have an emission direction, or excitation direction, originating from the spiral head in a radial direction. The scroll compressor in FIG. 2 is arranged on the transverse axis 19 such that the emission direction, or the excitation direction, of the vibrations extends along the transverse axis 19 orthogonally to a longitudinal direction of the vehicle.

FIGS. 3 to 11 show further possible orientations and positions at which the heat pump module 10 can be positioned, or arranged, in a vehicle. FIGS. 3 to 11 each show a schematic view of a vehicle from above. Each of the figures schematically shows the arrangement and position of the heat pump module 10, front and rear tires, and a passenger compartment 20.

In FIG. 3, the heat pump module 10 is arranged in a front region of the vehicle. The heat pump module 10 is arranged on a right side of the vehicle. More precisely, the heat pump module 10 is arranged on the passenger's side of the vehicle. The compressor unit 11 extends orthogonally to a longitudinal direction of the vehicle.

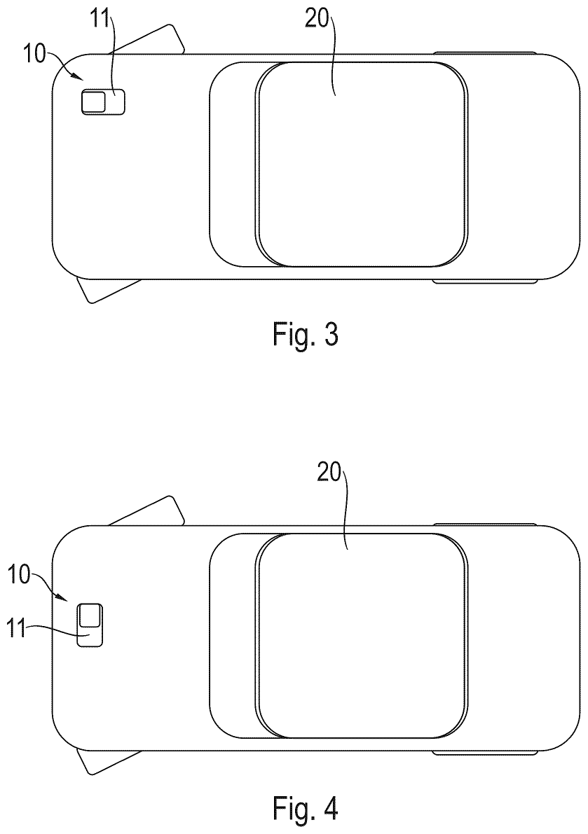

FIG. 4 shows an arrangement of the heat pump module 10 in a front region of a vehicle. The heat pump module 10 is arranged on the vehicle in the middle in the transverse direction. The compressor unit 11 extends orthogonally to a direction of travel of the vehicle when all tires are oriented parallel to each other.

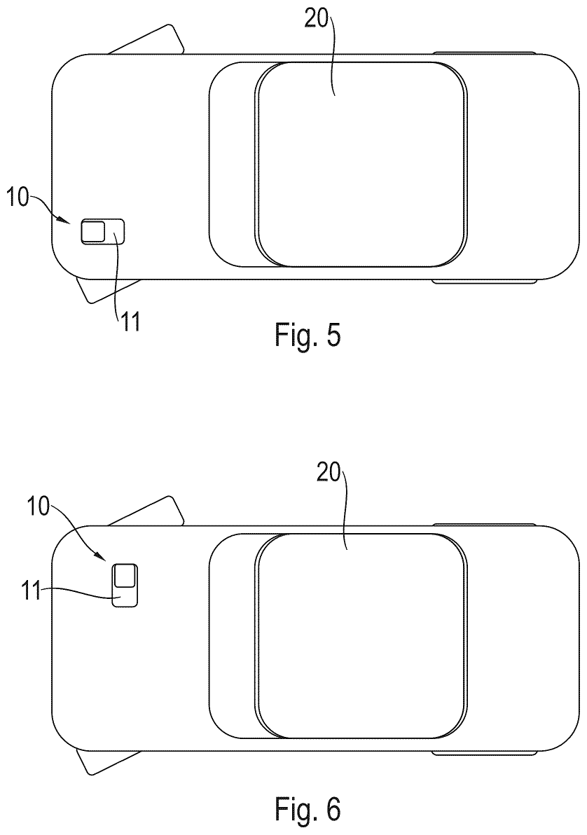

FIG. 5 shows an arrangement of the heat pump module 10 in a front region of the vehicle. The heat pump module 10 is arranged on the left side of the vehicle, or on the driver's side. The compressor unit 11 extends orthogonally to a longitudinal direction of the vehicle.

FIG. 6 shows an arrangement of the heat pump module 10 that is similar to the embodiment shown in FIG. 3. In contrast to the embodiment shown in FIG. 3, the heat pump module 10 shown in FIG. 6 is parallel to the transverse direction of the vehicle.

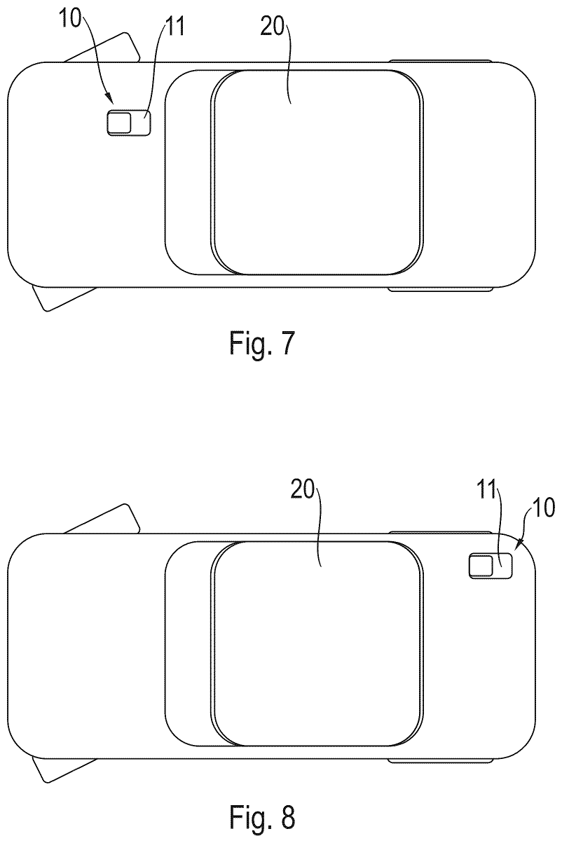

FIG. 7 shows an arrangement of the heat pump module 10 in a front region of the vehicle, wherein the heat pump module 10 is located on the passenger's side of the vehicle. The compressor unit 11 of the heat pump module 10 extends, in FIG. 7, in a longitudinal direction of the vehicle. The heat pump module 10 is arranged closer to the passenger compartment 20 than, for example, the heat pump module 10 shown in FIG. 3.

FIG. 8 shows an arrangement of the heat pump module 10 in a rear region of the vehicle. The heat pump module 10 is arranged on the passenger's side. The heat pump module 10 extends parallel to a longitudinal direction of the vehicle.

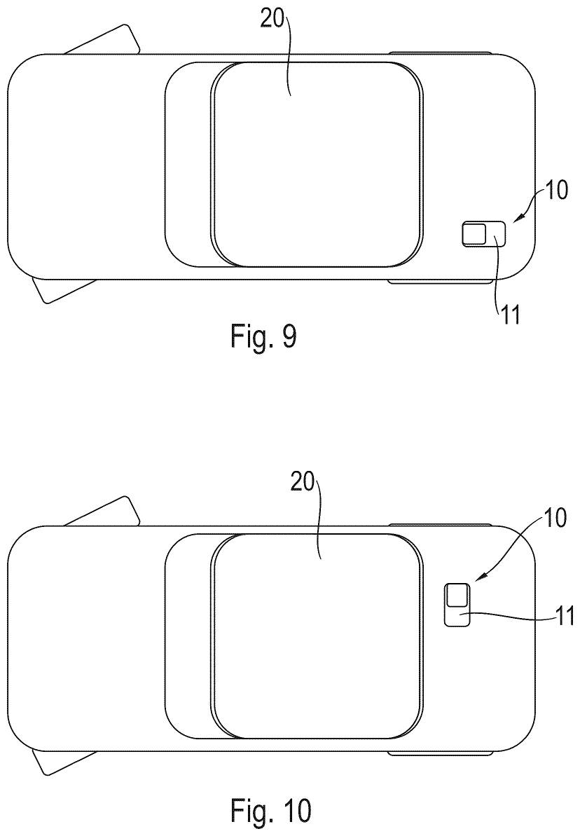

FIG. 9 shows a location of the heat pump module 10 in the rear region of a vehicle. The heat pump module 10 is located on the driver's side of the vehicle. The drivable component 11 extends parallel to a longitudinal direction of the vehicle.

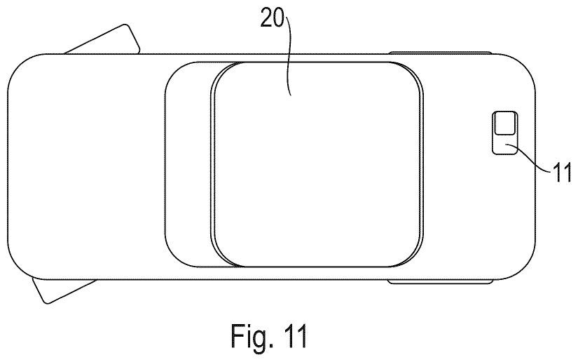

FIG. 10 and FIG. 11 both show an arrangement of the heat pump module 10 in a rear region of the vehicle, wherein the heat pump module 10 extends parallel to a transverse direction of the vehicle. In FIG. 10, the heat pump module 10 is arranged closer to the passenger compartment 20 of the vehicle than the heat pump module 10 shown in FIG. 11.

In consideration of the possible emission directions, or excitation directions, which are dependent on the drivable component 11, it is advantageous to select the installation orientation and/or installation position of the drivable component 11, for example a scroll compressor, such that the emission direction, or the excitation direction, of the vibrations does not extend in the longitudinal direction of a body structure of the vehicle, which is a direct path into the passenger compartment 20. It is therefore advantageous to select the position and orientation of the drivable component 11 such that introduced excitations due to vibrations act perpendicularly on the body structures and thus a direct transmission into a passenger compartment 20 of the vehicle is avoided.

The heat pump module 10 can be arranged at different positions on a vehicle (cf. FIGS. 3 to 11). The position and orientation of the heat pump module can differ from vehicle to vehicle. Furthermore, the heat pump module 10 can be arranged, for example, on a body element of the vehicle. It is particularly advantageous when the body element extends in a transverse direction of the vehicle. For example, the heat pump module 10 can be arranged on a crossmember, or axle beam, of the vehicle. Alternatively, it is conceivable that the heat pump module is provided together with an axle assembly for the vehicle, in particular being installed together with the axle assembly in the vehicle. Alternatively, it is conceivable that the heat pump module 10 is arranged on a cross-brace, in particular a suspension cross-brace.

It is also possible to arrange the drivable component 11 directly on a vehicle so that the vibrations generated by the drivable component 11 are not transmitted or are at least damped and, in particular, are decoupled from a vehicle structure of the vehicle.

Other embodiments of the present invention are possible and can be understood and implemented by persons skilled in the art by studying the figures, the disclosure, and the accompanying claims when applying the claimed subject matter. In particular, the parts/functions of each of the above-described embodiments can also be combined with one another. Furthermore, various steps of the method can be carried out in an order other than the order disclosed herein. In the claims, the word “including” does not exclude the presence of further elements or steps and the indefinite article “a” or “an” does not exclude the presence of a plurality. The mere mention of some measures in several different dependent claims is not to be understood as meaning that a combination of these measures cannot also be used advantageously. Reference characters in the claims are not to be understood restrictively.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

10 heat pump module
11 drivable component
12 decoupling element
13 support element
14 elastic connector
15 cutout
16 structural element
17 evaporator unit
18 condenser unit
19 transverse axis
20 passenger compartment

1-10: (canceled)

11. A heat pump module (10) for an electric vehicle or a hybrid vehicle, the heat pump module (10) comprising:
a drivable component (11) configured to generate vibrations during operation; and
a decoupling element (12) configured to decouple the drivable component (11) such that generated vibrations are not transmitted or are at least damped to decouple the drivable component (11) from a vehicle structure of a vehicle when the heat pump module (10) is installed in the vehicle.

12. The heat pump module (10) of claim 11, wherein the heat pump module (10) comprises a support element (13) configured to support the drivable component (11) and to attach the heat pump module (10) to the vehicle.

13. The heat pump module (10) of claim 12, wherein the decoupling element (12) is arranged on the support element (13) and is configured to connect the heat pump module (10) to a structural element of a vehicle.

14. The heat pump module (10) of claim 13, wherein at least some parts of the support element (13) have an irregular geometry.

15. The heat pump module (10) of claim 11, wherein the decoupling element (13) comprises at least two elastic connectors (14).

16. The heat pump module (10) of claim 15, wherein each of the elastic connectors (14) of the decoupling element (13) has a different spring stiffness.

17. The heat pump module (10) of claim 15, wherein the elastic connectors (14) are asymmetrically arranged in space.

18. The heat pump module (10) of claim 15, wherein at least some parts of the decoupling element (12) have an irregular geometry.

19. The heat pump module (10) of claim 11, wherein:
the heat pump module (10) comprises a support element (13) configured to support the drivable component (11) and to attach the heat pump module (10) to the vehicle; and
at least some parts of the support element (13) include cutouts (15);
the cutouts (15) have differing, irregular geometries.

20. An axle assembly, comprising:
the heat pump module (10) of claim 11; and
two wheel heads spaced apart in an axial direction of the axle assembly,
wherein the heat pump module (10) is arranged on the axle assembly by the decoupling element (12) such that the vibrations generatable by the drivable component (11) are emitted in an emission direction, and
wherein the emission direction runs at least partially along the axial direction and/or orthogonally thereto.

21. A vehicle, comprising the heat pump module (10) of claim 11, wherein the heat pump module (10) is arranged by the decoupling element (12) such that vibrations generated by the component (11) are mechanically decoupled from a passenger compartment of the vehicle.
